(19) United States
(12) Patent Application Publication
(10) Pub. No.: US 2026/0368727 A1
(43) Pub. Date: Nov. 19, 2026

(54) TRANSACTION PROCESSING DURING NETWORK OUTAGE LEVERAGING A DISTRIBUTED NETWORK OF ATMS

(71) Applicant: Bank of America Corporation, Charlotte, NC (US)

(72) Inventors: Anbarasan Murthy, Chennai (IN); Parakala Chandana, Nellore (IN); Tamilvannan Murugan, Chennai (IN); Saraswathi Saraswathi, Thoothukkudi (IN); Prajakta Uttam Jagdale, Hadapsar (IN); Dharanipriya Baratharaman, Sembanarkoil (IN); Vetrivel Gunasekaran, Tiruvannamalai (IN)

(21) Appl. No.: 19/208,733

(22) Filed: May 15, 2025

(51) Int. Cl. G06Q 20/40; G06Q 20/10; H04L 67/104

(52) U.S. Cl. CPC G06Q 20/401; G06Q 20/1085; H04L 67/104

(57) ABSTRACT

A method for authenticating and executing transactions at an automated teller machine (“ATM”) when a network connection between the ATM and a central server is not available is provided. The method may leverage a peer-to-peer (“P2P”) network connection between a plurality of ATMs. The method may include receiving a transaction request from a user at a first ATM. In response to determining that the first ATM fails to connect to the central server, operating the plurality of ATMs in a P2P mode. The P2P mode using the P2P network connection between the plurality of ATMs to aggregate user transaction data from each ATM for executing the transaction. The P2P mode may include initiating the P2P network connection with the plurality of ATMs and following the initiating of the P2P connection, syncing user transaction data from each of a second ATM and a third ATM for processing the transaction request.

### FIELD OF TECHNOLOGY

Aspects of the disclosure relate to transaction processing during a network outage.

### BACKGROUND OF THE DISCLOSURE

Automated teller machines (“ATMs”) rely heavily on continuous network connectivity to operate. When network connection is not available due to natural disasters, technical disruptions, or Wi-Fi connectivity issues, ATMs are inoperable. When inoperable, users cannot use ATMs for basic functions such as withdrawing cash or accessing essential banking services.

Existing solutions include mobile tethering or the use of local storage, but they come with limitations. With mobile tethering, the ATM can connect to a mobile network by linking to a user's device, but this solution depends on the availability and reliability of a user's mobile data, which can be problematic during disasters. Local storage allows ATMs to function in a limited capacity by storing customer data and authentication information locally, but managing synchronization, data security, and operational accuracy pose security risks.

Thus, there is a need for a more robust, secure, and automated system that enables ATMs to operate seamlessly and safely during network disruptions to ensure continuous service availability and reliable access to funds in emergency scenarios.

In addition, user behavior and activity are typically handled at a central server. It would be desirable to provide systems and methods to enable analyzing user behavior, in real time in a distributed network, when network connectivity has been disrupted.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative diagram in accordance with principles of the disclosure.

FIG. 2 shows an illustrative flow diagram in accordance with principles of the disclosure.

FIG. 3 shows an illustrative diagram in accordance with principles of the disclosure.

FIG. 4 shows an illustrative block diagram in accordance with principles of the disclosure.

FIG. 5 shows an illustrative apparatus that may be configured in accordance with principles of the disclosure.

### DETAILED DESCRIPTION OF THE DISCLOSURE

A method for enabling authenticating and executing transactions at an ATM when a network connection between the ATM and a central server is not available is provided. The enabling may be facilitated via a peer-to-peer (“P2P”) network connection with a plurality of ATMs. The P2P network connection may be enabled when the plurality of ATMs are within a pre-determined range of one another.

The plurality of ATMs may include a first ATM, a second ATM, and a third ATM or any other suitable number of ATMs that may be within a proximity to connect via a P2P network.

The pre-determined range may be a range that may enable short-range network communication. The short-range network communication may enable the ATMs to leverage data stored at each ATM within the pre-determined range for authenticating and executing transactions. The pre-determined range may enable a network connection including Lora Wan, Lifi, and any other suitable P2P network connection.

Each ATM may operate as a node on a distributed network. Each ATM may serve as both a client and a server when the network connection to the central server is not operable. Each ATM may leverage a ledger for maintaining and storing transactions executed while the network connection is not operable.

The method may include receiving a transaction request from a user at a first ATM. The transaction request may be a request for a withdrawal of funds. The transaction request may be a request for a statement of transactions. The transaction request may be any other suitable transaction request.

The method may include determining whether there is a network connection available for connecting to the central server.

In response to determining that the first ATM fails to connect to the central server, the method may include determining whether the second ATM and the third ATM also fail to connect to the central server.

In response to determining that each of the plurality of ATMs fail to connect to the central server, the method may include operating the plurality of ATMs in a P2P mode. The P2P mode may leverage the P2P network connection between the plurality of ATMs to aggregate user transaction data. The user transaction data aggregated from each of the ATMs may be used to either authenticate or deny the execution of the transaction request.

The P2P mode may include initiating the P2P connection with the plurality of ATMs.

Following the initiating of the P2P connection, the method may include syncing user transaction data from each of the second ATM and the third ATM for processing the transaction request. The syncing may include transmitting a request to each of the plurality of ATMs for user transaction data associated with transactions executed by the user while each of the plurality of ATMs fail to connect to the central server.

The user transaction data may include a timestamp of execution of each transaction request executed at the ATM while the ATM fails to connect to the central server. The user transaction data may include the transactions where the timestamp is within a pre-determined duration of time from the time the network connection was determined to fail to connect to the central server. The pre-determined duration of time may be a few minutes, a few hours, 24 hours, two days or any other suitable pre-determined duration of time.

In some embodiments, the syncing may include sharing the user transaction data from each of the first ATM, the second ATM and the third ATM to each respective ATM thereby maintaining a most updated dataset at each of the ATMs.

In response to the transmitting, the method may include receiving from a second ATM, second ATM-specific user transaction data associated with transactions executed by the user while the network connection is disconnected. Second ATM-specific user transaction data may be stored on a second ledger at the second ATM. The second ATM-specific user transaction data may include, for each transaction executed by the user, a time of execution of the transaction and a second transaction amount.

The method may also include receiving from a third ATM, third ATM-specific user transaction data associated with transactions executed by the user while the network connection is disconnected. The third ATM-specific user transaction data may be stored on a third ledger at the third ATM. The third ATM-specific user transaction data may include, for each transaction executed by the user, a time of execution of the transaction and a third transaction amount.

Each ATM may also store a database of user profiles. The database of user profiles may be updated periodically when connected to the central server. Each user profile may also include a total value of funds in the user's account.

When it is determined that the user did not perform transactions at any of the ATMs during the network disconnection, the method may include using the value of funds stored in the user profile from a most recent updated user profile for authenticating the transaction.

The method may also include retrieving a server-based user threshold value from the first ATM. The server-based user threshold value may be a value generated at the central server while the network connection is established.

The server-based user threshold value may be a value generated using ML and AI. A ML engine running at the central server may analyze each transaction a user performs and continuously update the server-based user threshold value based on user behavior, transactions executed, transactions denied or any other suitable behavior and/or activity.

The method may include aggregating the second transaction amount and the third transaction amount for determining a total transaction amount. The total transaction amount may be the amount that the user transacted during the pre-determined duration of time while the network connection is disconnected.

When the total transaction amount is less than or equal to the server-based user threshold value, the method may include authenticating the execution of the transaction request.

In response to authenticating the transaction request, the method may include executing the transaction request at the ATM.

When the total transaction amount is greater than the server-based user threshold value, the method may include pausing the execution of the transaction request and requesting additional authentication from the user prior to executing the transaction request.

In some embodiments, the additional authentication may include user biometrics, a one-time passcode or any other suitable additional authentication. Following the additional authentication, the transaction request may be executed. In some embodiments following the additional authentication, the transaction request may be denied.

When the transaction request is less than the pre-determined maximum amount but greater than the server-based user threshold value, the method may include providing the user with a half of the total amount of the transaction request.

Following execution of the transaction request, the method may include updating a first ledger stored at the first ATM to include the transaction.

When the network connection is available, the method may include updating the central server to include the transaction request.

In some embodiments, prior to authenticating the transaction request, the method may include retrieving from the second ATM and the third ATM, a total amount of transactions executed by the user while the network connection is disconnected.

When the total amount of transactions executed by the user at the second ATM and the third ATM exceeds a pre-determined maximum amount, the method may include denying the transaction request at the first ATM.

Following the denying of the transaction request at the first ATM, the method may include transmitting an alert notification message, via p2p, to the second ATM and the third ATM to deny each transaction request received from the user during a time the network connection is disconnected.

For example, a user may try to exploit the network outage by attempting to withdraw funds from numerous ATMs. The user may assume that the local ATM servers can't access real-time balance information and therefore will not be aware of recent withdrawals. However, the systems and methods of the invention may detect numerous attempted transactions initiated by a single user at multiple ATMs within a short time period and subsequently decline to execute the withdrawals.

When the system detects a number of attempted transaction requests submitted by the same user at more than one ATM within a short range of time, the system may automatically deny requests received from the user. The system may deny requests, at least preferably during the duration of time that the network connection to the central server is not operable.

A system for enabling authenticating and executing transactions at a first ATM when a network connection between the first ATM and a central server is not available is provided. The enabling may be the P2P network connection with a plurality of ATMs within a pre-determined range to the ATM. The plurality of ATMs may include the first ATM, a second ATM and a third ATM.

The system may include a first ATM configured to receive a transaction request initiated by a user. The user may be a customer of a financial entity. The central server may be hosting the financial entity's system.

The first ATM may be configured to determine a network connection availability between the ATM and the central server.

In response to determining that the network connection is not available, the first ATM may be configured to operate in a P2P network connection mode. The P2P network connection mode may leverage the P2P network connection between the plurality of ATMs to aggregate user transaction data for authenticating and executing the transaction request.

The P2P network connection mode may include initiating the P2P connection with the plurality of ATMs. Following the initiating of the P2P connection, the first ATM may be configured to transmit a request to each of the plurality of ATMs for user transaction data associated with transactions executed by the user while the network connection is disconnected.

The second ATM may be configured to receive the request from the first ATM. The second ATM may be further configured to extract second ATM-specific user transaction data stored at a second ATM database for transactions executed by the user. The second ATM-specific user transaction data may include, for each transaction executed by the user, a time of execution of the transaction and a second transaction amount.

The second ATM may also be configured to transmit the second ATM-specific user transaction data to the first ATM.

The third ATM may be configured to receive the request from the first ATM.

The third ATM may be configured to extract third ATM-specific user transaction data stored at a third ATM database for transactions executed by the user. The third ATM-specific user transaction data may include, for each transaction executed by the user, a time of execution of the transaction and a third transaction amount.

The third ATM may be configured to transmit the third ATM-specific user transaction data to the first ATM.

The first ATM may be further configured to receive the second ATM-specific user transaction data from the second ATM. The first ATM may be configured to receive the third ATM-specific user transaction data from the third ATM.

In some embodiments user transaction data may not exist at either or both of the second ATM and the third ATM. This may occur when the user did not execute any transactions since the central server is disconnected at either the second ATM, the third ATM or both the second and the third ATM.

Following a receipt of data from the second ATM and the third ATM, the first ATM may also be configured to retrieve a server-based user threshold value stored at a first ATM database. The server-based user threshold value may be a value generated at the central server while network connection is established. The server-based user threshold value may be based on transactional data generated while the ATM is enabled to connect to the central server.

The first ATM may be configured to aggregate the second transaction amount and the third transaction amount for determining a total transaction amount.

When the total transaction amount is less than or equal to the server-based user threshold value, the first ATM may be configured to authenticate the execution of the transaction request.

In response to authenticating the transaction, the first ATM may be configured to execute the transaction request at the ATM.

When the total transaction amount is greater than the server-based user threshold value, the first ATM may be configured to pause the execution of the transaction request and request additional authentication from the user.

In some embodiments, following a receipt of the user transaction data from each of the second ATM and the third ATM, the first ATM may compare the timestamp of each transaction. When the second ATM-specific user transaction data and the third ATM-specific user transaction data include a timestamp of execution of a transaction that are both within a pre-determined time range to a time of receipt of the transaction request at the first ATM, the first ATM may be configured to deny the transaction request.

At the central server, when the network connection is available, the central server may be configured to receive from each of the ATM, the second ATM and the third ATM, all the data associated with transactions executed at each of the ATMs while the ATMs were not able to connect to the central server. The central server may leverage the timestamp associated with each transaction in comparison to the time the network connection was disrupted to enable syncing the data with the data stored at the central server.

Illustrative embodiments of apparatus and methods in accordance with the principles of the invention will now be described with reference to the accompanying drawings, which form a part hereof. It is to be understood that other embodiments may be utilized, and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

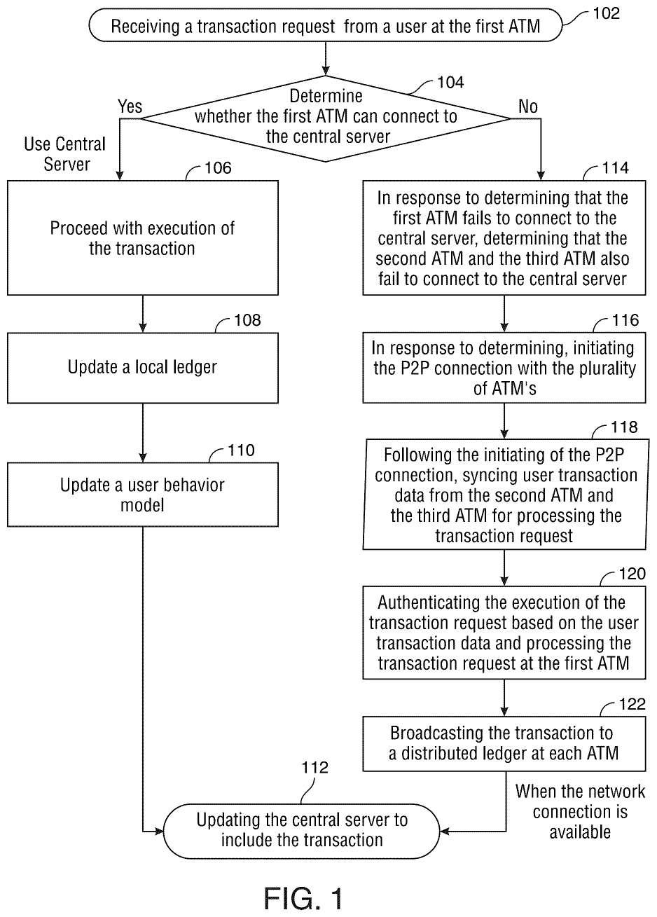

FIG. 1 shows an illustrative flow chart of the method steps for executing transactions via a P2P network connection between a plurality of decentralized nodes in accordance with principles of the disclosure. The plurality of decentralized nodes may include the first ATM, the second ATM and the third ATM.

At step 102, the method may include receiving a transaction request from a user at the first ATM. The user may be a customer initiating a transaction at the first ATM.

At step 104, the method may include determining whether central server connectivity is available. When the first ATM successfully establishes connection with the central server, the method may include step 106. At step 106, the method may include proceeding with executing the transaction. At step 108, the method may include updating a local ledger. At step 110, the method may include updating a user behavior model stored at the ATM. The user behavior model may be a model generated using artificial intelligence (“AI”) and machine learning (“ML”). The user behavior model may learn the behaviors of the user at the ATM. The user behavior model may enable setting threshold limits for the user when transacting during a network outage.

During a network outage, the ATM may leverage user transaction data from each of the plurality of ATMs for authenticating and executing the transaction request. In some embodiments, when there are no transactions executed by the user at any one or more of the plurality of ATMs, the ATM may leverage the user behavior model for determining whether or not to authenticate the transaction. The user behavior model may include a number of transactions executed by the user, types of transactions executed by the user, transaction amount commonly requested and any other suitable user behavior.

At step 112, the method may include updating the central server to include the transaction request.

In some embodiments, at step 104 the method may include determining that the first ATM fails to establish network connection with the central server. In response to the failure, at step 114 the method may include determining whether the second ATM and the third ATM also fail to connect to the central server. In response to determining that there is a failure, the method may include initiating a P2P connection with the plurality of ATMs, as shown at 116.

At step 118, the method may include, following the initiating of the P2P connection, syncing user transaction data from each of a second ATM and a third ATM for processing the transaction request at the first ATM.

At step 120, the method may include authenticating the execution of the transaction request based on the user transaction data received from each of the second ATM and the third ATM. Following authentication, the method may include processing the transaction request at the first ATM.

At step 122, the method may include adding the transaction to a first ledger stored at the first ATM.

When the network connection between the first ATM and the central server is successfully established, the method may include updating the central server to include the transaction request, as shown at 112.

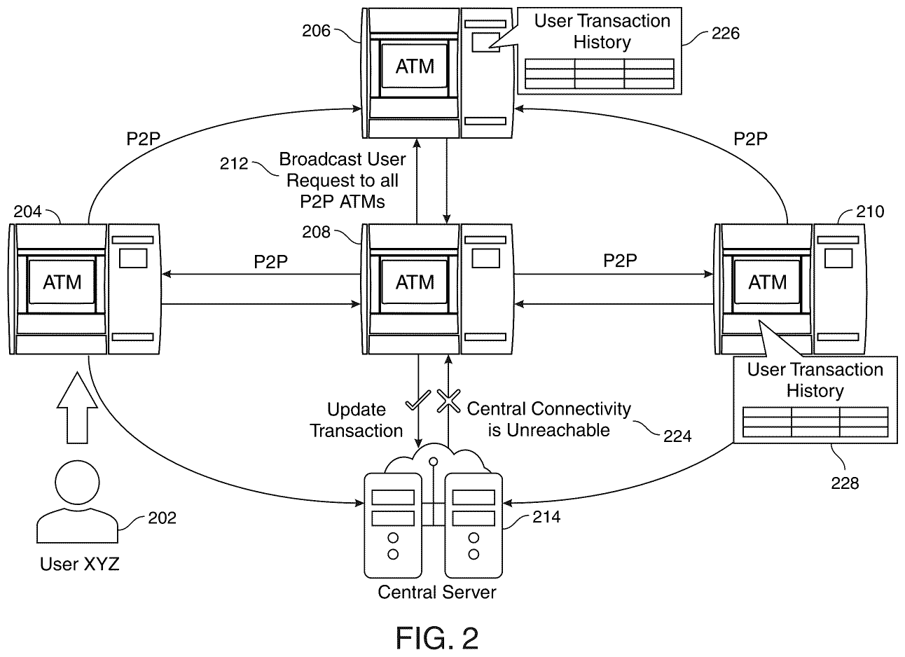

FIG. 2 shows an illustrative architecture diagram of a plurality of ATMs operating in a P2P mode in accordance with principles of the disclosure. The plurality of ATMs may include ATM 204, ATM 206, ATM 208 and ATM 210. Each ATM may be in electronic communication with central server 214 for processing transactions. There may be a network connection between the central server and each ATM.

In this exemplary diagram, user XYZ, shown at 202, may initiate a transaction at ATM 204. ATM 204 may attempt to connect to the central server for processing the transaction.

At 224, ATM 204 and each of the plurality of ATMS are not enabled to connect to central server 214.

Following the determination that the network connection to the central server 214 is disconnected, ATM 204 may execute a P2P network connection 216 between each of the plurality of ATMs.

ATM 204 may broadcast the transaction request to each ATM via P2P network connection, as shown at 212. In response to broadcasting the transaction request, each ATM may search through a database running at the ATM for transactions executed by the user within a pre-determined time period to the initiating of the transaction by the user at ATM 204.

The pre-determined time period may include the time the network connection to the central server is down. In some embodiments, the pre-determined time period may include a portion of the duration of time that the network connection to the central server is not available.

Following the searching via each ATM, each ATM may transmit user transaction data associated with the user. In some embodiments, one or more ATMs may not have any transactions executed by the user during the pre-determined time period.

ATM 206 may identify one or more transactions in the user transaction history 226 that are associated with user 202. ATM 210 may also identify one or more transactions in the user transaction history 228 that are associated with user 202.

ATM 204 may leverage the user transaction data received from each ATM for determining whether to authenticate the transaction initiated by the user at 204.

When the transaction request is authenticated and executed, ATM 204 may add the transaction and the associated data from the transaction request to a first ledger stored on the first ATM.

When network connection between each ATM and the central server 214 is restored, central server 214 may retrieve the transaction data from the first ATM, the user transaction data from each of the second ATM and the third ATM, synchronize the data and update the central server.

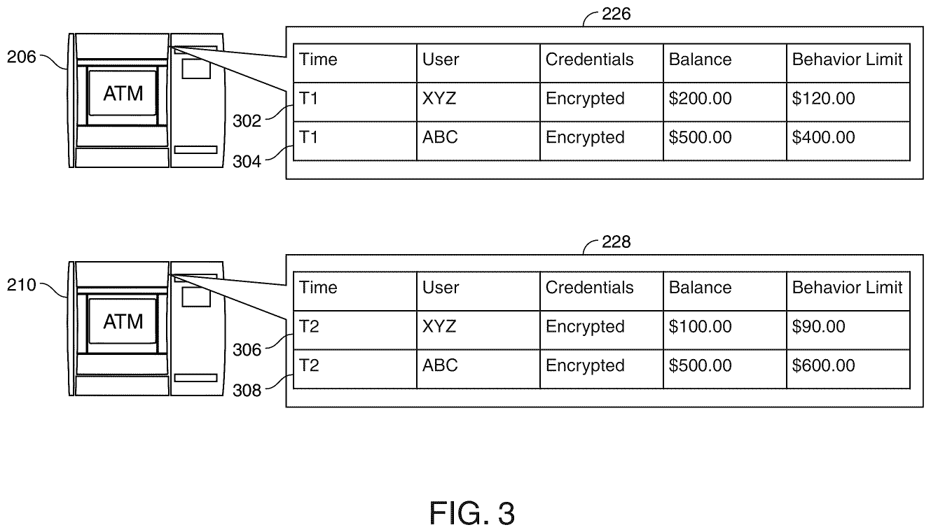

FIG. 3 shows an exemplary diagram of user transaction data associated with transactions executed by the user while network connection is not available.

User transaction history 226 may be stored on a second ledger at the second ATM. User transaction history 226 may display user transaction history associated with transactions executed at the second ATM.

User transaction history 228 may be stored on a third ledger at the third ATM. User transaction history 228 may display user transaction history associated with transactions executed at the third ATM.

At ATM 206, at time ‘T1’, user XYZ had a balance of $200.00 with a behavior limit of $120.00, as shown at 302. At time ‘T1’, user ABC had a balance of $500.00 with a behavior limit of $400.00, as shown at 304.

At ATM 210, at time ‘T2’, user XYZ had a balance of $100.00 and a behavior limit of $90.00, as shown at 306. At time ‘T2’, user ABC had a balance of $500.00 and a behavior limit of $600.00, as shown at 308.

This user transaction data may be leveraged using ML and AI to determine whether the transaction initiated by user 202 at ATM 204 may be authenticated and executed.

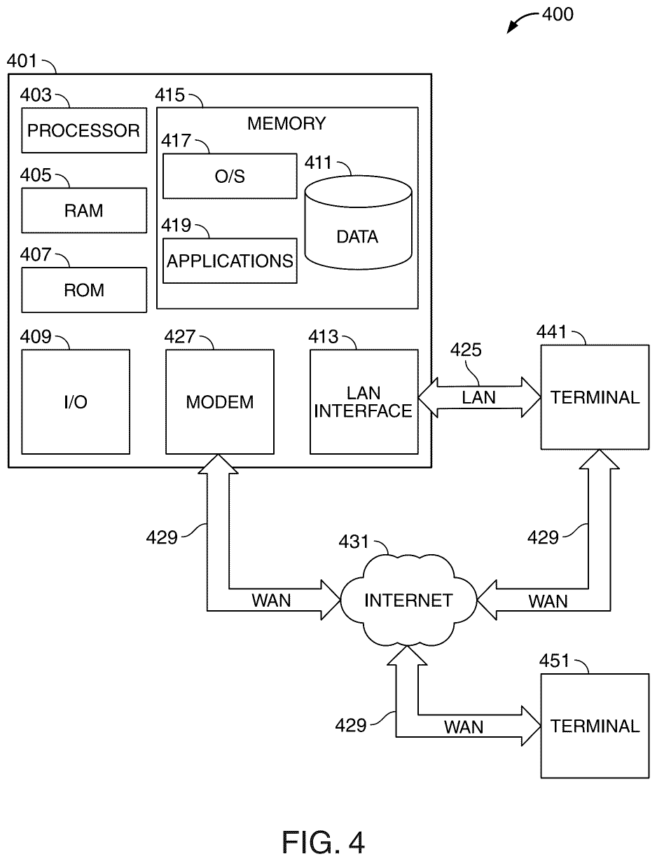

FIG. 4 shows an illustrative block diagram of system 400 that includes computer 401. Computer 401 may alternatively be referred to herein as an “engine,” “server” or a “computing device.” The computing system may include one or more computer servers 401. Computer 401 may be any computing device described herein including the central server, the first ATM, the second ATM, the third ATM, any one or more additional ATMs, and any other suitable computing device. Elements of system 400, including computer 401, may be used to implement various aspects of the systems and methods disclosed herein.

Computer 401 may have a processor 403 for controlling the operation of the device and its associated components, and may include RAM 405, ROM 407, input/output circuit 409, and a non-transitory or non-volatile memory 415. Machine-readable memory may be configured to store information in machine-readable data structures. Other components commonly used for computers, such as EEPROM or Flash memory or any other suitable components, may also be part of the computer 401.

The memory 415 may be comprised of any suitable permanent storage technology—e.g., a hard drive. The memory 415 may store software including the operating system 417 and application(s) 419 along with any data 411 needed for the operation of computer 401. Memory 415 may also store videos, text, and/or audio assistance files. The data stored in Memory 415 may also be stored in cache memory, or any other suitable memory.

Input/output (“I/O”) module 409 may include connectivity to a microphone, keyboard, touch screen, mouse, and/or stylus through which input may be provided into computer 401. The input may include input relating to cursor movement. The input/output module may also include one or more speakers for providing audio output and a video display device for providing textual, audio, audiovisual, and/or graphical output. The input and output may be related to computer application functionality.

Computer 401 may be connected to other systems via a local area network (LAN) interface 413. Computer 401 may operate in a networked environment supporting connections to one or more remote computers, such as terminals 441 and 451. Terminals 441 and 451 may be personal computers or servers that include many or all of the elements described above relative to computer 401.

When used in a LAN networking environment, computer 401 is connected to LAN 425 through a LAN interface 413 or an adapter. When used in a WAN networking environment, computer 401 may include a modem 427 or other means for establishing communications over WAN 429, such as Internet 431.

In some embodiments, computer 401 may be connected to one or more other systems via a short-range communication network (not shown). In these embodiments, computer 401 may communicate with one or more other terminals 441 and 451, using a PAN such as Bluetooth®, NFC, ZigBee, or any other suitable personal area network. Computer 401 may communicate with one or more other terminals using a P2P network connection.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 419, which may be used by computer 401, may include computer executable instructions for invoking functionality related to communication, such as e-mail, Short Message Service (SMS), and voice input and speech recognition applications. Application program(s) 719 (which may be alternatively referred to herein as “plugins,” “applications,” or “apps”) may include computer executable instructions for invoking functionality related to performing various tasks. Application programs 419 may utilize one or more algorithms that process received executable instructions, perform power management routines or other suitable tasks.

Application program(s) 419 may include computer executable instructions (alternatively referred to as “programs”). The computer executable instructions may be embodied in hardware or firmware (not shown). The computer 401 may execute the instructions embodied by the application program(s) 419 to perform various functions.

Application program(s) 419 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 419 may include one or more algorithms that may be used to implement features of the disclosure.

The invention may be described in the context of computer-executable instructions, such as applications 419, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 401 and/or terminals 441 and 451 may also include various other components, such as a battery, speaker, and/or antennas (not shown). Components of computer system 401 may be linked by a system bus, wirelessly or by other suitable interconnections. Components of computer system 401 may be present on one or more circuit boards. In some embodiments, the components may be integrated into a single chip. The chip may be silicon-based.

Terminal 451 and/or terminal 441 may be portable devices such as a laptop, cell phone, Blackberry™, tablet, smartphone, or any other computing system for receiving, storing, transmitting and/or displaying relevant information. Terminal 451 and/or terminal 441 may be one or more user devices. Terminals 451 and 441 may be identical to computer 401 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smart phones, multiprocessor systems, microprocessor-based systems, cloud-based systems, programmable consumer electronics, network PCs, minicomputers, mainframe computers, distributed computing environments that include any of the above systems or devices, and the like.

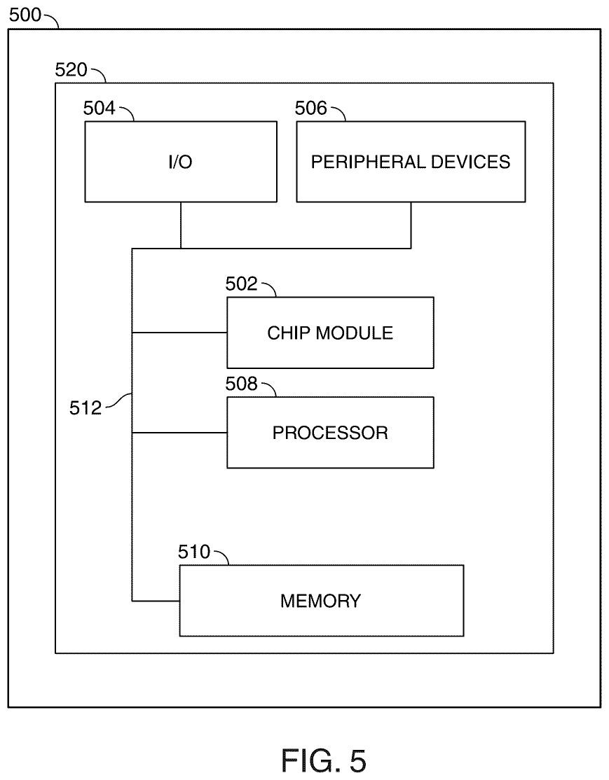

FIG. 5 shows illustrative apparatus 500 that may be configured in accordance with the principles of the disclosure. Apparatus 500 may be a computing device. Apparatus 500 may include chip module 502, which may include one or more integrated circuits, and which may include logic configured to perform any other suitable logical operations.

Apparatus 500 may include one or more of the following components: I/O circuitry 504, which may include a transmitter device and a receiver device and may interface with fiber optic cable, coaxial cable, telephone lines, wireless devices, PHY layer hardware, a keypad/display control device or any other suitable media or devices; peripheral devices 506, which may include counter timers, real-time timers, power-on reset generators or any other suitable peripheral devices; logical processing device 508, which may compute data structural information and structural parameters of the data; and machine-readable memory 510.

Machine-readable memory 510 may be configured to store in machine-readable data structures: machine executable instructions, (which may be alternatively referred to herein as “computer instructions” or “computer code”), applications such as applications 519, signals, and/or any other suitable information or data structures.

Components 502, 504, 506, 508 and 510 may be coupled together by a system bus or other interconnections 512 and may be present on one or more circuit boards such as circuit board 520. In some embodiments, the components may be integrated into a single chip. The chip may be silicon-based.

Thus, systems and methods for authenticating and executing transactions at an ATM, leveraging a P2P network connection, when a network connection between the ATM and a central server is not available is provided. Persons skilled in the art will appreciate that the present invention can be practiced by other than the described embodiments, which are presented for purposes of illustration rather than of limitation.

What is claimed is:

1. A method for authenticating and executing transactions at an automated teller machine (“ATM”) when a network connection between the ATM and a central server is not available, the method leveraging a peer-to-peer (“P2P”) network connection between a plurality of ATMs, the plurality of ATMs comprising a first ATM, a second ATM and a third ATM, the method comprising:
receiving a transaction request from a user at the first ATM;
determining that the first ATM fails to connect to the central server;
in response to determining that the first ATM fails to connect to the central server, determining that the second ATM and the third ATM also fail to connect to the central server;
in response to determining that each of the plurality of ATMs fail to connect to the central server, operating the plurality of ATMs in a P2P mode, the P2P mode using the P2P network connection between the plurality of ATMs to aggregate user transaction data from each of the plurality of ATMs for authenticating and executing the transaction request, the P2P mode comprising:
initiating the P2P network connection with the plurality of ATMs;
following the initiating of the P2P connection, syncing user transaction data from each of the second ATM and the third ATM for processing the transaction request, the syncing comprising:
transmitting a request to each of the plurality of ATMs for user transaction data associated with transactions executed by the user while the network connection is disconnected;
in response to the transmitting:
receiving from the second ATM, second ATM-specific user transaction data stored on a second ledger at the second ATM, the second ATM-specific user transaction data being associated with transactions executed by the user while the network connection is disconnected, the second ATM-specific user transaction data comprising, for each transaction executed by the user, a time of execution of the transaction and a second transaction amount; and
receiving from the third ATM, third ATM-specific user transaction data stored on a third ledger at the third ATM, the third ATM-specific user transaction data being associated with transactions executed by the user while the network connection is disconnected, the third ATM-specific user transaction data comprising, for each transaction executed by the user, a time of execution of the transaction and a third transaction amount;
aggregating the second transaction amount and the third transaction amount for determining a total transaction amount;
in response to the total transaction amount being less than or equal to a server-based user threshold value, the server-based user threshold value being a value generated at the central server while the network connection is established:
authenticating the execution of the transaction request; and
in response to authenticating the transaction, processing the transaction request at the first ATM;
following the processing of the transaction request, adding the transaction to a first ledger stored at the first ATM; and
when the network connection is available, updating the central server to include the transaction request.

2. The method of claim 1 wherein the P2P network connection is enabled via a low-range wide area network (“LoraWan”) connection.

3. The method of claim 1 further comprising, retrieving from the second ATM and the third ATM, a total amount of transactions executed by the user while the network connection is disconnected.

4. The method of claim 3 wherein, when the total amount of transactions executed by the user at the second ATM and the third ATM exceeds a pre-determined maximum amount, the method comprises denying the transaction request at the first ATM.

5. The method of claim 4 wherein following the denying of the transaction request at the first ATM, the method comprises transmitting an alert notification message via p2p to the second ATM and the third ATM to deny each transaction request received from the user during a time the network connection is disconnected.

6. The method of claim 4 wherein, when the transaction request is less than the pre-determined maximum amount but greater than the server-based user threshold value, providing the user with a half of the total amount of the transaction request.

7. The method of claim 1 wherein each of the first ATM, the second ATM, and the third ATM are decentralized nodes.

8. The method of claim 7 wherein when the plurality of ATMs are enabled to establish the network connection with the central server, the method comprises updating the central server based on data stored on a ledger at each of the first ATM, the second ATM and the third ATM.

9. A system for enabling authenticating and executing transactions at a first automated teller machine (“ATM”) when a network connection between the first ATM and a central server is not available, the enabling via a peer-to-peer (“P2P”) network connection with a plurality of ATMs within a pre-determined range to the ATM, the plurality of ATMs comprising the first ATM, a second ATM and a third ATM, the system comprising:
a first ATM configured to:
receive a transaction request initiated by a user;
determine a network connection availability between the ATM and the central server;
in response to determining that the network connection is not available, operate in a P2P mode, the P2P mode using the P2P network connection between the plurality of ATMs to aggregate user transaction data for authenticating and executing the transaction request, the P2P mode comprising:
initiate the P2P connection with the plurality of ATMs;
following the initiating of the P2P connection, transmit a request to each of the plurality of ATMs for user transaction data associated with transactions executed by the user while the network connection is disconnected;
the second ATM configured to:
receive the request from the first ATM;
extract second ATM-specific user transaction data from a second ledger stored at the second ATM, the second ATM-specific user transaction data comprising, for each transaction executed by the user, a time of execution of the transaction and a second transaction amount;
transmit the second ATM-specific user transaction data to the first ATM;
the third ATM configured to:
receive the request from the first ATM;
extract third ATM-specific user transaction data from a third ledger stored at the third ATM, the third ATM-specific user transaction data comprising, for each transaction executed by the user, a time of execution of the transaction and a third transaction amount;
transmit the third ATM-specific user transaction data to the first ATM;
the first ATM configured to:
receive the second ATM-specific user transaction data;
receive the third ATM-specific user transaction data;
retrieve a server-based user threshold value stored at a first ATM database, the server-based user threshold value being a value generated at the central server while network connection is established;
aggregate the second transaction amount and the third transaction amount for determining a total transaction amount;
when the total transaction amount is less than or equal to the server-based user threshold value, authenticate the execution of the transaction request;
in response to authenticating the transaction, executing the transaction request at the ATM;
when the total transaction amount is greater than the server-based user threshold value, pause the execution of the transaction request and requesting additional authentication from the user; and
adding the transaction to a first ledger stored at the first ATM; and
at the central server:
when the network connection is available, update the central server based on user transaction data retrieved from, the second ledger and the third ledger.

10. The system of claim 9 wherein the P2P connection is enabled via a low-range wide area network (“LoraWan”) connection.

11. The system of claim 9 wherein the first ATM is further configured to retrieve from the second ATM and the third ATM, a total amount of transactions executed by the user while the network connection is not established.

12. The system of claim 11 wherein, when the total amount of transactions executed by the user at the second ATM and at the third ATM exceeds a pre-determined maximum amount, the first ATM is configured to deny the transaction request.

13. The system of claim 12 wherein following a denial of the transaction request via the first ATM, the first ATM is configured to transmit an alert notification message via p2p to the second ATM and the third ATM to deny any transaction request received from the user.

14. The system of claim 13 wherein, when the transaction request is less than the pre-determined maximum amount but greater than the server-based user threshold value, the first ATM is configured to allow a withdrawal of funds up to a half of the total amount of the transaction request.

15. The system of claim 14 wherein, when the second ATM-specific user transaction data and the third ATM-specific user transaction data comprise a timestamp of execution of a transaction that are both within a pre-determined time range to a time of receipt of the transaction request at the first ATM, the first ATM is configured to deny the transaction request.

16. The system of claim 9 wherein the server-based user threshold value is recorded at each of the first ATM, the second ATM, and the third ATM and continuously updated while network connection to the central server is available.

17. A method for enabling authenticating and executing transactions at an ATM when a network connection between the ATM and a central server is not available, the enabling via a peer-to-peer (“P2P”) network connection with a plurality of ATMs within a pre-determined range to the ATM, the method comprising:
receiving a transaction request from a user at a first ATM;
determining a network connection availability to the central server;
in response to determining that the network connection is disconnected, operating the first ATM in a P2P mode, the P2P mode using the P2P network connection between the plurality of ATMs to aggregate user transaction data for authenticating and executing the transaction request, the P2P mode comprising:
initiating the P2P connection with the plurality of ATMs;
following the initiating of the P2P connection, transmitting a request to each of the plurality of ATMs for user transaction data associated with transactions executed by the user while the network connection is disconnected;
in response to the transmitting:
receiving from a second ATM, second ATM-specific user transaction data associated with transactions executed by the user while the network connection is disconnected, the second ATM-specific user transaction data comprising, for each transaction executed by the user, a time of execution of the transaction and a second transaction amount; and
receiving from a third ATM, third ATM-specific user transaction data associated with transactions executed by the user while the network connection is disconnected, the third ATM-specific user transaction data comprising, for each transaction executed by the user, a time of execution of the transaction and a third transaction amount;
retrieving a server-based user threshold value from the first ATM, the server-based user threshold value being a value generated at the central server while the network connection is established;
aggregating the second transaction amount and the third transaction amount for determining a total transaction amount;
when the total transaction amount is less than or equal to the server-based user threshold value, authenticating the execution of the transaction request;
in response to authenticating the transaction, executing the transaction request at the ATM;
when the total transaction amount is greater than the server-based user threshold value, pausing the execution of the transaction request and requesting additional authentication from the user, the additional authentication comprising:
retrieving from the second ATM and the third ATM, a total amount of transactions executed by the user while the network connection is disconnected;
when the total amount of transactions executed by the user at the second ATM and the third ATM exceeds a pre-determined maximum amount, denying the transaction request at the first ATM; and
when the total amount of transactions executed by the user at the second ATM and at the third ATM is lower than the pre-determined maximum amount, authenticating the transaction request;
updating a first ledger stored at the first ATM to record the transaction; and
when the network connection is available, updating the central server to include the transaction request.

18. The method of claim 17 further comprising retrieving, via the central server, the user transaction data from each of the first ATM, the second ATM and the third ATM for updating the central server.

19. The method of claim 17 wherein the server-based user threshold value is recorded at each of the first ATM, the second ATM, and the third ATM and continuously updated while network connection to the central server is available.

20. The method of claim 17 wherein following the denying of the transaction request at the first ATM, the method comprises transmitting an alert notification message via p2p to the second ATM and the third ATM to deny any transaction request received from the user.
